(19) United States
(12) Patent Application Publication
(10) Pub. No.: US 2008/0170141 A1
(43) Pub. Date: Jul. 17, 2008

(54) Folded package camera module and method of manufacture

(76) Inventors: Samuel Waising Tam, Daly City, CA (US); Dongkai Shangguan, San Jose, CA (US)

Correspondence Address: HENNEMAN & ASSOCIATES, PLC, 714 W. MICHIGAN AVENUE, THREE RIVERS, MI, 49093, US

(21) Appl. No.: 11/652,405

(22) Filed: Jan. 11, 2007

(51) Int. Cl. H04N 5/335

(52) U.S. Cl. 348/294; 348/E05.091

(57) ABSTRACT

An image-capture-device/processor package includes a flexible circuit substrate, an image capture device mounted on the flexible circuit substrate, a second device (e.g., processor) mounted on the flexible substrate, and a stiffener for at least partially supporting the second device. The ICD and the second device may be flip-chip mounted to the same surface of the flexible circuit substrate. The flexible circuit substrate may be folded so that the ICD is positioned back-to-back with the second device. The flexible circuit substrate may further include Land Grid Array (LGA) pads formed thereon to facilitate electrical connection with a host device.

### BACKGROUND

1. Technical Field

The present invention relates generally to digital camera modules. Even more particularly, the present invention relates to image capture device (ICD) packages incorporating a processor in a flip-chip mount configuration.

2. Description of the Background Art

Digital camera modules are currently being incorporated into a variety of host devices. Such host devices include cellular telephones, personal data assistants (PDAs), computers, etc. And, consumer demand for digital camera modules in host devices continues to grow.

Host device manufacturers prefer digital camera module to be small, so that they can be incorporated into the host device without increasing the overall size of the host device. Further, host device manufacturers desire camera modules that minimally affect host device design. Further, camera module and host device manufacturers want the incorporation of the camera modules into the host devices not to compromise image quality.

A conventional digital camera module generally includes a lens assembly, a housing, a printed circuit board (PCB), and an image capture device (ICD). Upon assembly, the ICD is electrically coupled to the PCB, which is affixed to the bottom of the housing. The lens assembly is mounted to the opposite end of the housing to focus incident light onto an image capture surface of the ICD. The PCB includes a plurality of electrical contacts that provide a communication path for the ICD to communicate image data to the host device for processing, display and storage.

It is difficult to incorporate prior art camera modules into host devices because camera module design often dictates host device design. For example, processors in host devices are often required to operate the prior art camera modules themselves. Accordingly, some prior art camera modules have been designed to incorporate processors therein. However, incorporating a processor and the associated attachment mechanisms (e.g., wire bonding, soldering, etc.) into the camera module adds substantial volume to the prior art camera module.

Accordingly, an improved digital camera module with an incorporated processor and manufacturing method are needed.

### SUMMARY

According to a first embodiment, the present invention provides a system, comprising a flexible substrate; an image capture device coupled to a first portion of said flexible substrate; a second device coupled to a second portion of said flexible substrate, said first portion and said second portion being positioned to define a folding portion therebetween such that when said folding portion is folded the image capture device and second device are disposed in a stacked relationship; and a stiffener positioned to at least partially support said second device.

The system may further comprise a lens housing affixed to said flexible substrate, e.g., using adhesive. The system may further comprise gold stud bumps on said image capture device; and thermo-compression bond coupling said image capture device to said flexible substrate. The image capture device may be affixed to said flexible substrate using nonconductive paste. The second device may be a processor. The processor may be coupled to said flexible substrate by gold stud bumps and thermo-compression bond. The processor may be affixed to said flexible substrate using nonconductive paste. The system may further comprise electrical contacts, e.g., Land Grid Array contacts, on the rear surface of the flexible substrate. The stiffener may be formed prior to affixing said stiffener to said flexible substrate, may be formed using a dam-and-fill process, and/or may be formed using an over-molding process. The image capture device and second device may be affixed to the same surface of said flexible substrate. The system may be mounted to receiving circuitry using surface mount technology.

According to another embodiment, the present invention provides a method, comprising providing a flexible circuit substrate; mounting an image capture device to said flexible circuit substrate; mounting a second device to said flexible circuit substrate; positioning a stiffener to at least partially support said second device; and folding said flexible substrate so that said image capture device and said second device are disposed in a stacked relationship.

The method may further comprise providing a lens housing and mounting said lens housing to said camera module. The method may further comprise molding said lens housing onto said flexible circuit substrate. The method may further comprise affixing said lens housing to flexible circuit substrate using adhesive. The method may further comprise forming gold stud bumps onto at least one of said image capture device and said second device; and thermo-compression bonding at least one of said image capture device and said second device to said flexible circuit substrate. The method may further comprise affixing at least one of said image capture device and said second device to said flexible circuit substrate using nonconductive paste. The method may further comprise forming Land Grid Array contacts onto said flexible circuit substrate. The method may further comprise forming said stiffener prior to affixing said stiffener to said flexible circuit substrate, forming said stiffener using a dam and fill process and/or forming a stiffener onto said flexible circuit substrate using an over-mold process.

### BRIEF DESCRIPTION OF THE DRAWINGS

The present invention is described with reference to the following drawings, wherein like reference numbers denote like elements:

FIG. 1 is a perspective view of a camera module affixed to a PCB, in accordance with an embodiment of the present invention;

FIG. 2 is an exploded perspective view of a camera module relative to a PCB, in accordance with an embodiment of the present invention;

FIG. 3 is an exploded perspective view of a camera module, in accordance with an embodiment of the present invention;

FIG. 4a illustrates an exploded perspective view of an unfolded ICD/processor package, in accordance with an embodiment of the present invention;

FIG. 4b is a perspective view of an unfolded ICD/processor package, in accordance with an embodiment of the present invention;

FIG. 5 is a exploded perspective rear view of an unfolded ICD/processor package, in accordance with an embodiment of the present invention;

FIG. 6 is a cross-sectional side view of a flexible circuit substrate, in accordance with an embodiment of the present invention;

FIG. 7 is a cross-sectional side view of a digital camera module, in accordance with an embodiment of the present invention;

FIG. 8 is a flowchart illustrating a method for manufacturing a digital camera module, in accordance with an embodiment of the present invention;

FIG. 9 is a flowchart illustrating a method for coupling a processor and a stiffener to a flexible circuit substrate, in accordance with an embodiment of the present invention; and

FIG. 10 is a flowchart illustrating a method for coupling an ICD to a flexible circuit substrate, in accordance with an embodiment of the present invention.

### DETAILED DESCRIPTION

Embodiments of the present invention overcome problems associated with the prior art by providing a system and method for manufacturing a digital camera module incorporating a processor in a flip-chip mount configuration. In the following description, specific details (e.g., lens housing designs, particular optical components, fixing means, etc.) are set forth to provide a thorough understanding of the various embodiments of the invention. Details of well-known practices (e.g., automated focus processes, materials selection, molding processes, etc.) and well-known components (e.g., electrical circuitry, device interfaces, etc.) have been omitted, so as not to obscure unnecessarily the description of the present invention.

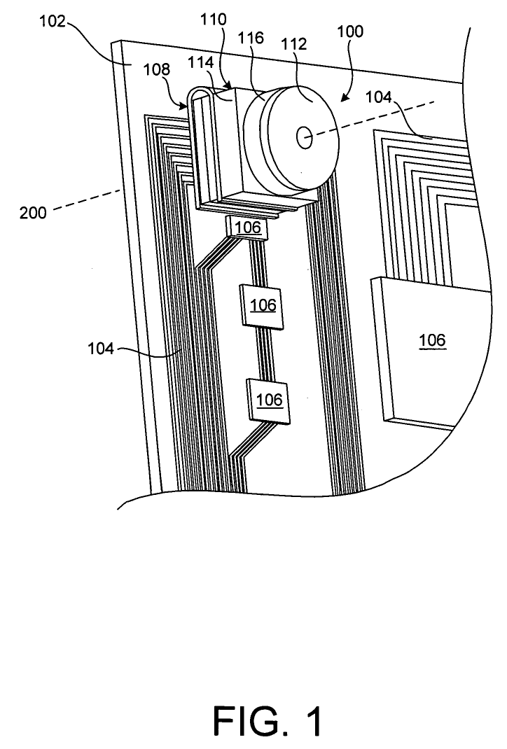

FIG. 1 is a perspective view of a camera module 100 affixed to a printed circuit board (PCB) 102, in accordance with an embodiment of the present invention. Camera module 100 is shown mounted via electrical contacts (not visible in FIG. 1) to a generally corner portion of PCB 102 of a host device (e.g., cellular telephone, PDA, laptop, etc.). PCB 102 communicates with other components, e.g., devices 106, of the host device via conductive traces 104. Those skilled in the art will recognize that various PCB 102 designs are possible.

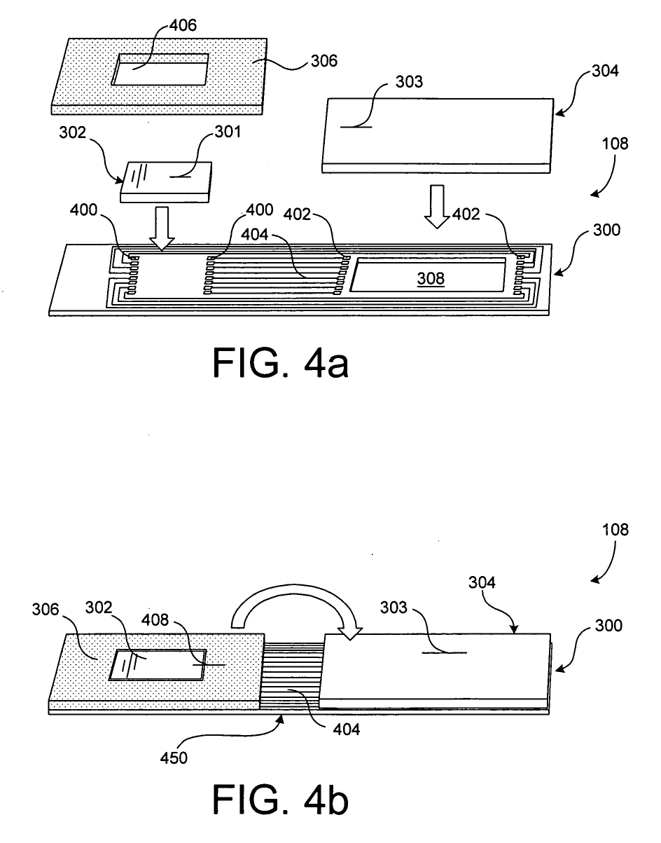

Camera module 100 includes an image-capture-device/processor package 108, a housing 110, and a lens unit 112. ICD/processor package 108 contains an image capture device (ICD) (see FIGS. 4a-7) and an image (e.g., JPEG) processor (see FIGS. 4a-7) in a flip-chip mount configuration. Housing 110 includes a housing base 114 coupled to the ICD/processor package 108, and a lens receptacle 116, e.g., a cylindrical wall, coupled to the housing base 110. In one embodiment, housing 110 is formed directly over ICD/processor package 108 by an over-molding technique known to those skilled in the art. In another embodiment, housing 110 is prefabricated, and attached to ICD/processor package 108 using adhesive (e.g., epoxy) and/or thermal welding.

Lens receptacle 116 is coupled to housing base 114 and defines an opening for receiving and supporting lens unit 112. It should be noted that lens unit 112 could be focused using various technique (e.g., threads, ramps, etc.). For example, lens unit 112 may be coupled to lens receptacle 116, for example, using conventional screw-type threading. Thus, by rotating the lens unit 112 within the lens receptacle 116, camera module 100 may focus light.

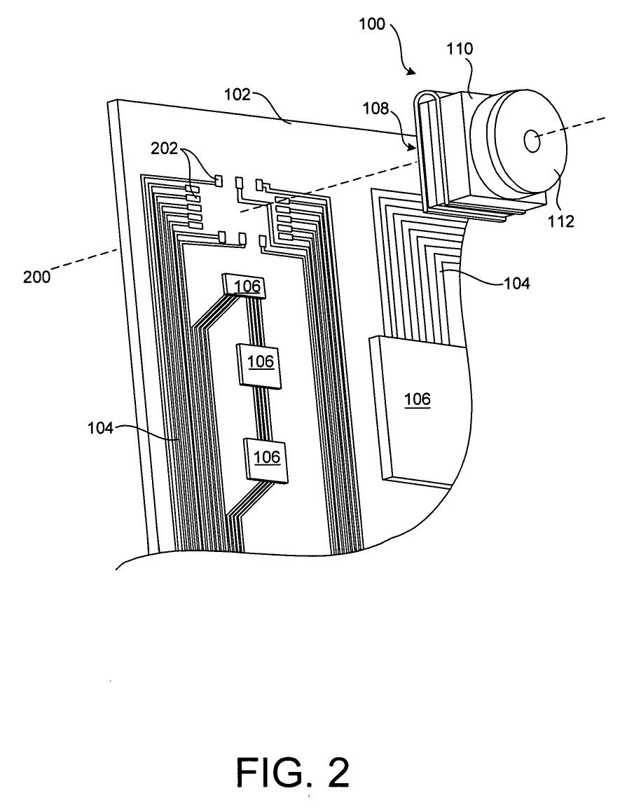

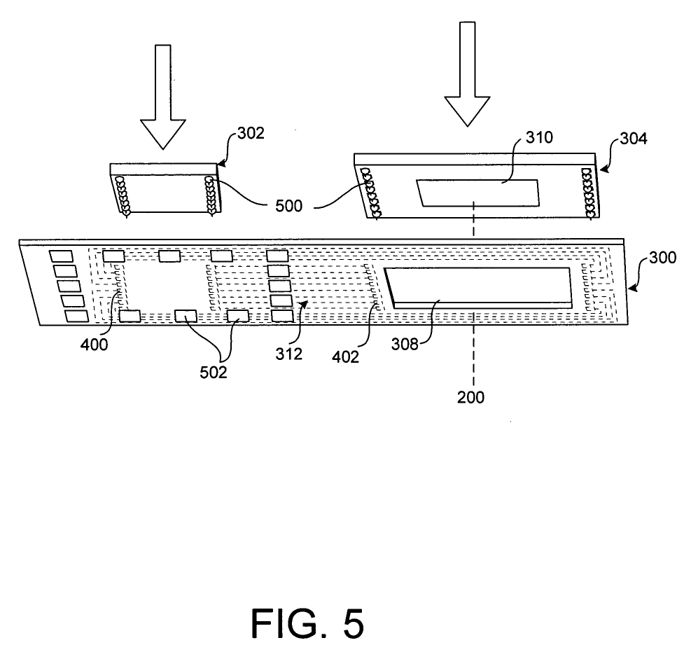

FIG. 2 shows an exploded perspective view of camera module 100 relative to the PCB 102, in accordance with an embodiment of the present invention. PCB 102 includes PCB contacts 202 to facilitate electrical connection between traces 104 and camera module 100 contacts (see FIG. 5). PCB contacts 202 may be, for example, Land Grid Array (LGA) solder ball connections or other contact mechanism. Camera module 100 may be moved and mounted to PCB 102 using pick-and-place machines (e.g., SMT machines) known to those skilled in the art.

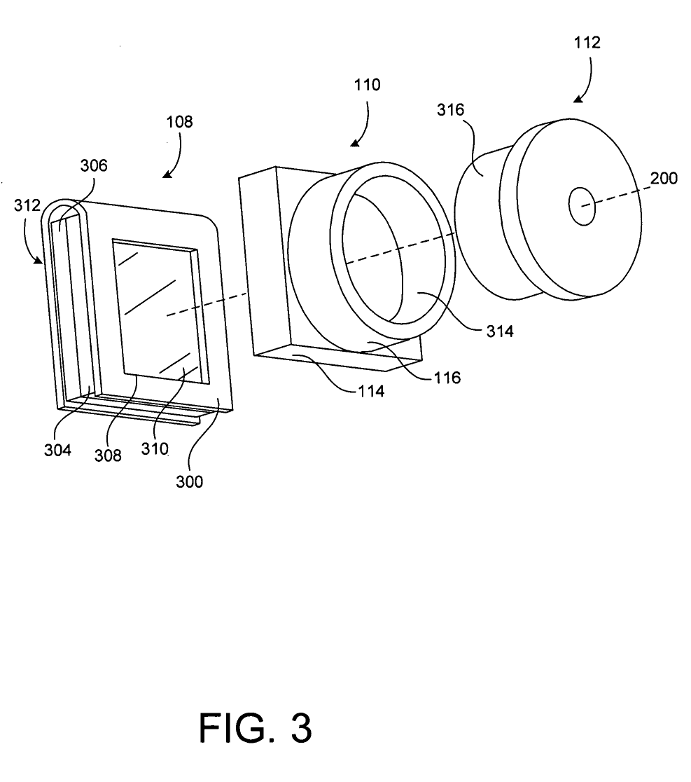

FIG. 3 shows an exploded perspective view of the camera module 100, in accordance with an embodiment of the present invention. As stated above, camera module 100 includes ICD/processor package 108, housing 110, and lens unit 112. As shown, ICD/processor package 108 includes a flexible printed circuit board (FPCB) 300, an ICD 304, and a stiffener 306. As further shown, FPCB 300 defines an aperture 308 e.g., opening, translucent and/or transparent window, etc.) that permits light traveling through the lens unit 112 and housing 110 to contact an ICD surface 310 of ICD 304. Lens receptacle 116 defines a bore 314 that receives a lens barrel 316 of lens unit 112. Although not shown, ICD/processor package 108 includes a processor 302 (see FIGS. 4a-7) surrounded by and/or adjacent to stiffener 306.

FIG. 4a illustrates an exploded perspective view of ICD/processor package 108 with FPCB 300 unfolded, in accordance with an embodiment of the present invention. As stated above, ICD/processor package 108 includes an FPCB 300, a processor 302, an ICD 304 and a stiffener 306. In one embodiment, FPCB 300 includes a strip of polyimide tape with processor-receiving contacts 400 (for electrically connecting to the processor 302) and ICD-receiving contacts 402 (for electrically connecting to the ICD 304) formed thereon. Conductive traces 404 may electrically connect processor-receiving contacts 400 and ICD-receiving contacts 402, and may be formed, for example, by photolithography. The layout (routing, number, size, shape, etc.) of processor-receiving contacts 400, ICD-receiving contacts 402 and conductive traces 404 may vary depending on the application.

As shown, the FPCB 300 defines an aperture 308 to enable light traveling through the lens unit 112 to contact ICD 304 when the FPCB 300 is folded.

In one embodiment, stiffener 306 is a prefabricated, rigid component that includes an aperture 406 to receive processor 302. In one embodiment, stiffener 306 has substantially the same rear surface perimeter as ICD 304, so that when stiffener 306 (with ICD 304) and processor 302 are positioned back-to-back, their perimeters coincide. In one embodiment, stiffener 306 may be substantially the same height as processor 302 to form a substantially level surface 408 to abut the substantially level surface 303 of ICD 304. It will be appreciated that stiffener 306 may provide rigidity to rear surface 312 of FPCB 300. By providing rigidity, stiffener 306 facilitates the application of pressure between the rear surface 312 and the PCB 102 and between the two surfaces 408 and 303. Further, by providing substantial rigidity to the portion of FPCB 300 surrounding and/or adjacent to processor 302 (which is smaller than ICD 304), stiffener 306 provides at least partial support to ICD 304 when processor 302 and ICD 304 are folded together. It will be appreciated that stiffener 306 can take on various shapes and/or positions to provide at least partial support to ICD 304.

In another embodiment, stiffener 306 is formed around processor 302 via, for example, using over-molding techniques. Alternatively or additionally, stiffener 306 could be formed using dam and fill techniques. It will be further appreciated that these stiffener-forming techniques may also be advantageous to support other passive components on FPCB 300 in addition to processor 302.

FIG. 4b is a perspective view of unfolded ICD/processor package 108, in accordance with an embodiment of the present invention. As shown, the stiffener 306 and processor 302 are mounted onto a left-side portion of the top surface of the FPCB 300, and the ICD 304 is mounted onto a right-side portion of the top surface of the FPCB 300. The space between the left-side portion and the right-side portion of the FPCB defines a foldable portion 450. When the foldable portion of the FPCB 300 is folded, the back surfaces 408 of processor 302 and stiffener 306 abut the back surface 303 of ICD 304.

FIG. 5 shows a rear exploded perspective view of processor 302 and ICD 304, in accordance with an embodiment of the present invention. Each of processor 302 and ICD 304 includes gold stud bumps 500 (or other electrically conductive metallic bumps, e.g. solder balls) to facilitate electrical connection to processor-receiving contacts 400 and ICD-receiving contacts 402, respectively. Processor 302 and ICD 304 may be physically connected to FPCB 300, for example, using thermo-compression and/or nonconductive paste.

A rear surface 312 of FPCB 300 includes a plurality of LGA pads 502 formed thereon to facilitate electrical connection, e.g., soldering, of camera module 100 and host device. Various layouts (e.g., number of pads, footprint shape, etc.) of LGA pads 502 are possible.

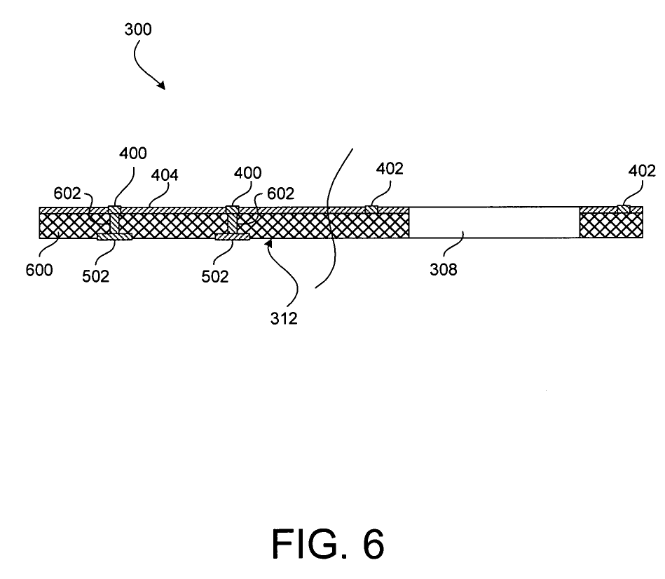

FIG. 6 shows an example cross-sectional side view of FPCB 300, in accordance with an embodiment of the present invention. FPCB 300 includes a flexible base layer 600 of, for example, polyimide. FPCB 300 further includes conductive traces 404 of, for example, copper. As shown and described, conductive traces 404 and vias 602 formed through FPCB 300 provide electrical pathways between processor-receiver contacts 400, ICD-receiving contacts 402, and LGA pads 502.

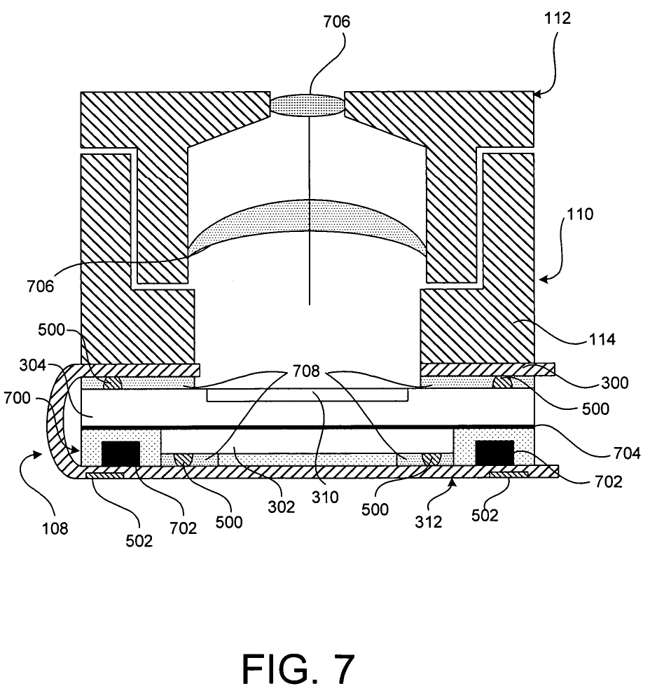

FIG. 7 shows a cross-sectional side view of camera module 100, in accordance with an embodiment of the present invention. Camera module 100 includes ICD/processor package 108, housing 110 and lens unit 112. ICD/processor package 108 includes FPCB 300, a stiffener 700 surrounding and/or adjacent to processor 302, and ICD 304. Processor 302 and ICD 304 is shown electrically coupled to FPCB 300 using gold stud bumps 500 and physically coupled to FPCP 300 using nonconductive paste 708. Processor 302 and ICD 304 are affixed back-to-back by adhesive 704. ICD/processor package 108 further includes LGA pads 502 contactable, flush and/or protruding from the rear surface 312, to enable connection to PCB 102. Lens unit 112 includes lenses 706 and other components (e.g., infrared filters, other optical filters, etc.) to focus light onto ICD surface 310. The particular optical components of lens unit 112 may vary according to application. It will be appreciated that stiffener 700 may encase and/or partially support passive components 702.

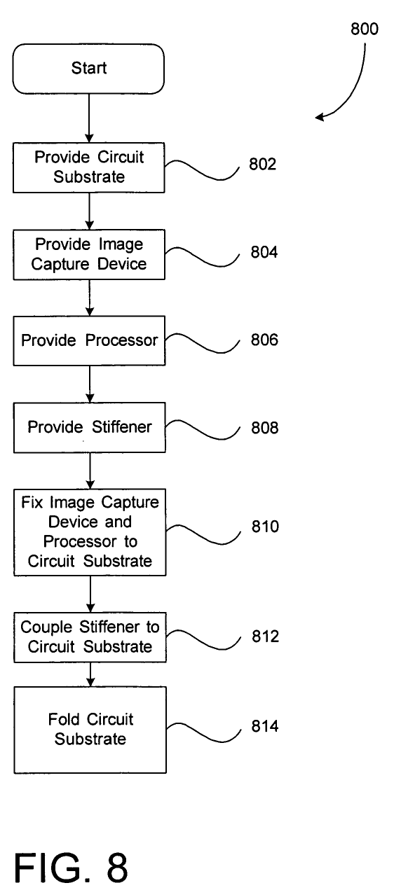

FIG. 8 is a flowchart illustrating a method 800 for manufacturing a digital camera module 100. In step 802, a flexible circuit substrate is provided. In step 804, an ICD is provided. In step 806, a processor is provided. In step 808, a stiffener is provided. In step 810, ICD and processor are affixed to the flexible circuit substrate. In step 812, the stiffener is coupled to the flexible circuit substrate. In step 814, the circuit substrate is folded so that the ICD and processor connect.

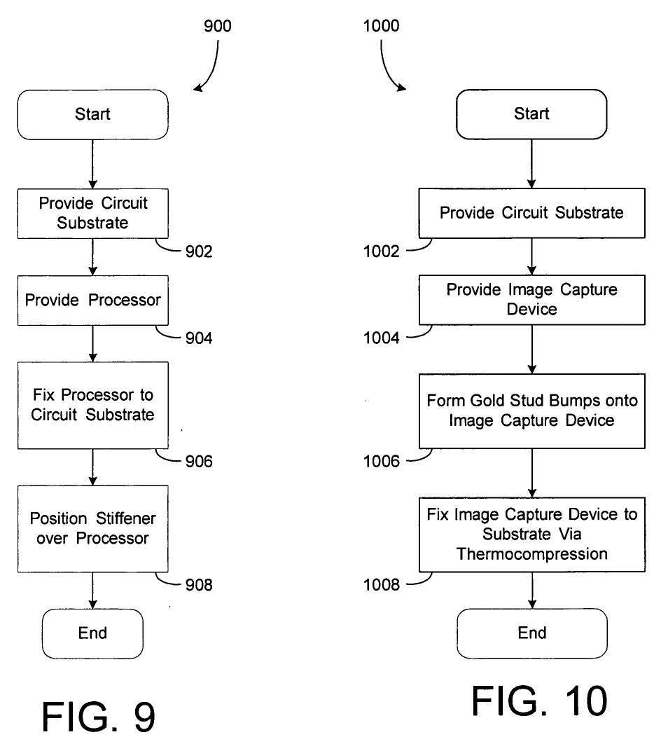

FIG. 9 is a flowchart illustrating a method 900 for coupling a processor and a stiffener to a flexible circuit substrate. In step 902, a flexible circuit substrate is provided. In step 904, a processor is provided. In step 906, the processor is affixed to the flexible circuit substrate. In step 908, a stiffener is positioned about the processor, e.g., via over-molding, lamination, affixing a prefabricated stiffener, and/or the like.

FIG. 10 is a flowchart illustrating a method 1000 for coupling an ICD to a circuit substrate. In step 1002, a circuit substrate is provided. In step 1004, an ICD is provided. In step 1006, gold stud bumps are formed on the ICD. In step 1008, the ICD is affixed via thermo-compression to the circuit substrate.

Many of the described features may be substituted, altered or omitted without departing from the scope of the invention. For example, alternate conducting materials (e.g., copper, aluminum, etc.), may be substituted for the contact pads and the connector pads disclosed. As another example, alternate lens housings may be substituted for the representative lens housing shown. Further, embodiments may be developed without a stiffener. These and other deviations from the particular embodiments shown will be apparent to those skilled in the art, particularly in view of the foregoing disclosure.

We claim:

1. A system, comprising:
a flexible substrate;
an image capture device coupled to a first portion of said flexible substrate;
a second device coupled to a second portion of said flexible substrate, said first portion and said second portion being positioned to define a foldable portion therebetween such that when said foldable portion is folded the image capture device and second device are disposed in a stacked relationship; and
a stiffener adjacent said second device for at least partially supporting said image capture device.

2. A system according to claim 1, further comprising a lens housing.

3. A system according to claim 2, wherein said lens housing is coupled to said flexible substrate.

4. A system according to claim 2, wherein said lens housing is affixed to said flexible substrate using adhesive.

5. A system according to claim 1, further comprising
gold stud bumps on said image capture device; and
thermo-compression bond coupling said image capture device to said flexible substrate.

6. A system according to claim 5, wherein said image capture device is affixed to said flexible substrate using nonconductive paste.

7. A system according to claim 1, wherein said second device is a processor.

8. A system according to claim 7, wherein said processor is coupled to said flexible substrate by electrically conductive metallic bumps coupled to said processor and thermo-compression bond coupling said processor to said flexible substrate.

9. A system according to claim 8, wherein said metallic bumps are gold stud bumps.

10. A system according to claim 8, wherein said metallic bumps are solder balls.

11. A system according to claim 8, wherein said processor is affixed to said flexible substrate using nonconductive paste.

12. A system according to claim 1, further comprising electrical contacts on the rear surface of the flexible substrate.

13. A system according to claim 12, wherein said electrical contacts are Land Grid Array contacts.

14. A system according to claim 1, wherein said stiffener is formed prior to positioning said stiffener adjacent said image capture device.

15. A system according to claim 1, wherein said stiffener is formed using a dam-and-fill process.

16. A system according to claim 1, wherein said stiffener is formed onto said flexible substrate using an over-molding process.

17. A system according to claim 1, wherein said image capture device and said second device are affixed to the same surface of said flexible substrate.

18. A system according to claim 1, suitable to be mounted to receiving circuitry using surface mount technology.

19. A system according to claim 1, wherein said stiffener surrounds said second device.

20. A system according to claim 1, wherein said flexible substrate defines an aperture through which light can impinge upon a surface said image capture device.

21. A method, comprising:
providing a flexible circuit substrate;
mounting an image capture device to said flexible circuit substrate;
mounting a second device to said flexible circuit substrate;
positioning a stiffener to at least partially support said second device; and
folding said flexible substrate so that said image capture device and said second device are disposed in a stacked relationship.

22. A method according to claim 21, further comprising providing a lens housing and mounting said lens housing to said camera module.

23. A method according to claim 22, further comprising molding said lens housing onto said flexible circuit substrate.

24. A method according to claim 22, further comprising affixing said lens housing to flexible circuit substrate using adhesive.

25. A method according to claim 21, further comprising:
forming gold stud bumps onto at least one of said image capture device and said second device; and
thermo-compression bonding at least one of said image capture device and said second device to said flexible circuit substrate.

26. A method according to claim 25, comprising affixing at least one of said image capture device and said second device to said flexible circuit substrate using nonconductive paste.

27. A method according to claim 21, further comprising forming Land Grid Array contacts onto said flexible circuit substrate.

28. A method according to claim 21, further comprising forming said stiffener prior to affixing said stiffener to said flexible circuit substrate.

29. A method according to claim 21, further comprising forming said stiffener using a dam and fill process.

30. A method according to claim 21, further comprising forming a stiffener onto said flexible circuit substrate using an over-mold process.
